(19) United States
(12) Patent Application Publication
(10) Pub. No.: US 2012/0033896 A1
(43) Pub. Date: Feb. 9, 2012

(54) Visual Motion Processing with Offset Downsampling

(76) Inventor: Geoffrey Louis Barrows, Washington, DC (US)

(21) Appl. No.: 12/852,506

(22) Filed: Aug. 8, 2010

(51) Int. Cl. G06K 9/46; G06K 9/00; G06K 9/32

(52) U.S. Cl. 382/295; 382/103; 382/190

(57) ABSTRACT

An algorithm for removing visual motion from a sequence of two or more images is disclosed. This algorithm may be performed with a camera system having an image sensor capable of downsampling the raw pixel image according to downsampling grid offset by a raw pixel amount. In a first exemplary embodiment a first and second downsampled image are grabbed at different times. Then the displacement between these downsampled images is computed. A third downsampled image is grabbed with an offset based on the displacement. The first and third downsampled images are lined up and cropped. If the camera system itself is moving, moving targets or other objects may be detected by parallax from the first and third downsampled images. In a second exemplary embodiment a block or feature is selected in the visual scene and then a first downsampled image is acquired. After a delay the motion of the block or feature is determined. A second downsampled image is acquired with an offset based on the motion of the block or feature. The first and second downsampled images are lined up and cropped. If the camera system itself is moving, moving targets or other objects may be detected by parallax from the first and second downsampled images.

### FEDERALLY SPONSORED RESEARCH

This invention was made with Government support under Contract Nos. FA8651-08-M-0129 and W31P4Q-06-C-0290 awarded respectively by the United States Air Force and the United States Army. The Government has certain rights in this invention.

### CROSS-REFERENCE TO RELATED APPLICATIONS

none.

### TECHNICAL FIELD

The teachings presented herein relate to electronic visual sensors and the processing of images acquired by these electronic visual sensors.

### BACKGROUND

Acquiring imagery at a single high resolution is problematic due the large amounts of raw pixel data acquired. This raw pixel data must be first digitized by an analog to digital converter (ADC) and then stored in memory and processed. The result is a limited frame rate that may be processed. Even if an extremely fast processor is used, the frame rate will be limited by the speed of the ADC.

Some image processing algorithms benefit from processing an image at multiple resolutions. To support this, a raw high resolution image may be smoothed with a Gaussian or other smoothing function then and downsampled by an integer amount to produce a set of different resolution images generated from the same scene. For example, a raw 640×480 image may be used to generate 320×240, 160×120, 80×60, 40×30, and 20×15 images all based on the same scene. Such a set of images is often referred to as a pyramid representation of the original raw 640×480 image.

Once the pyramid representation has been obtained, the image scene may first be processed at one of the lower resolutions, with the result used to affect the processing of the imagery at higher resolutions. For example, coarse measurements may be taken at the lowest resolution, with these measurements refined using the higher resolution imagery. Alternative processing schemes are possible, for example a low resolution image may be used to detect the presence of objects such as moving targets, and a window of higher resolution imagery may then be taken of individual objects for further analysis.

Refer to FIG. 1, which shows the pixel arrangement of an m×n (m-by-n) image of raw pixels 101. The coordinate pair i,j refers to the raw pixel at row i and column j of the image. For purposes of discussion and without loss of generality, row 1 will refer to the topmost row 103 and column 1 will refer to the leftmost column 105. Thus pixel 1,1 is the top left raw pixel 107.

It is possible to define a “super pixel” by averaging the values of a set of adjacent pixels. For example, in FIG. 1 super pixels may be formed from the averages of 2×2 blocks of pixels, with super pixel 111 formed from the average of the four pixels from the top two rows and left two columns. Aggregating functions such as sums, geometric means, or other functions may be used in place of averages. Other super pixels may be similarly defined across the whole array, for example super pixels 113 and 115. Super pixel 113 in this example is formed from the 2×2 block of raw pixels in rows 1 and 2 and columns 3 and 4, while super pixel 115 is formed from the block of raw pixels in rows 3 and 4 and columns 1 and 2. It is also possible to define super pixels from square or rectangular blocks of different sizes, or even of shapes other than rectangular. It will be clear to the reader that by using super pixels of increasingly large sizes (e.g. 2×2, 4×4, and 8×8 blocks of raw pixels, and so on), a pyramid representation of a raw image may be constructed.

Image sensor systems have been disclosed that are able to directly acquire super pixels from a raw pixel array, and thus acquire images a multiple resolutions from the same image sensor. Such a sensor may be referred to as a “variable acuity” sensor. Generally there are two methods for generating such super pixels. In the first prior art method, the pixel circuits include switches or transistors between adjacent pixels that allow blocks of such pixels to be electrically shorted together so that they have the same value. Then just one of the pixels of the super pixel may be read out and digitized. In the second prior art method, the super pixels are formed during readout, with capacitor circuits used to integrate or share the charge across all the pixels of a super pixel to form a single output value. Both methods have the advantage that only the values associated with the super pixels need to be digitized and stored, and thus it is not necessary to first acquire the image at a high resolution and then mathematically compute a downsampled image.

Fossum et al in U.S. Pat. No. 5,949,483 entitled “Active pixel sensor array with multiresolution readout” disclose an image sensor capable of generating rectangular super pixels using the aforementioned second prior art method of charge sharing. Baxter et al in U.S. Pat. No. 7,408,572 entitled “Method and apparatus for an on-chip variable acuity imager array incorporating roll, pitch, and yaw angle rates measurement” disclose an image sensor capable of generating super pixels of arbitrary shapes using the aforementioned first prior art method of electrically shorting adjacent pixels.

The prior art on the construction of image sensors for use in camera systems is extensive. One useful book is “CMOS Imagers: From Phototransduction to Image Processing”, edited by O. Yadid-Pecht and R. Etienne-Cummings, and published by Kluwer Academic Publishers in 2004. Another useful book is “Vision Chips”, by Alireza Moini, and published by Kluwer Academic Publishers in 2000. The contents of both of these books are incorporated herein by reference.

The prior art in the implementation of image processing algorithms is similarly extensive. Four useful books on image processing include the following: Machine Vision, Third Edition: Theory, Algorithms, Practicalities, by E. R. Davies, published by Morgan Kaufmann in 2005; Digital Image Processing, by Rafael Gonzalez and Richard Woods, published by Pearson Prentice Hall in 2008; Feature Extraction and Image Processing, Second Edition, by Mark Nixon and Alberto Aquado, published by Academic Press in 2008; and Statistical Methods and Models for Video-Based Tracking, Modeling, and Recognition by Rama Chellappa et. al. and published by Now Publishers, Inc. in 2010. The contents of these four books are incorporated herein by reference.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 shows the pixel arrangement of an m-by-n image of raw pixels;

FIG. 2A shows the 16×16 array of raw pixels;

FIG. 2B shows how a 16×16 array of raw pixels may be downsampled by a factor of 4 to a 4×4 array of super pixels;

FIG. 2C depicts the 16×16 array of raw pixels downsampled by a factor of 4 with a horizontal offset;

FIG. 2D depicts the 16×16 array of raw pixels downsampled by a factor of 4 with both a horizontal and vertical offset;

FIG. 3 is used to describe parallax as observed by a moving platform;

FIG. 4 depicts a first exemplary algorithm for detecting objects by parallax and by using offset downsampling;

FIG. 5 depicts a second exemplary algorithm for detecting objects by parallax and by using offset downsampling;

FIG. 6 depicts a third exemplary algorithm for detecting objects by parallax and by using offset downsampling;

FIG. 7A depicts three sequential frames of offset downsampled images used as an example;

FIG. 7B shows the third frame of FIG. 7A with the motion of the moving target clearly indicated; and

FIG. 8 shows the same visual scene of FIG. 3, except that the first air vehicle is traveling in a serpentine path.

### DESCRIPTIONS OF EXEMPLARY EMBODIMENTS

Offset Downsampling

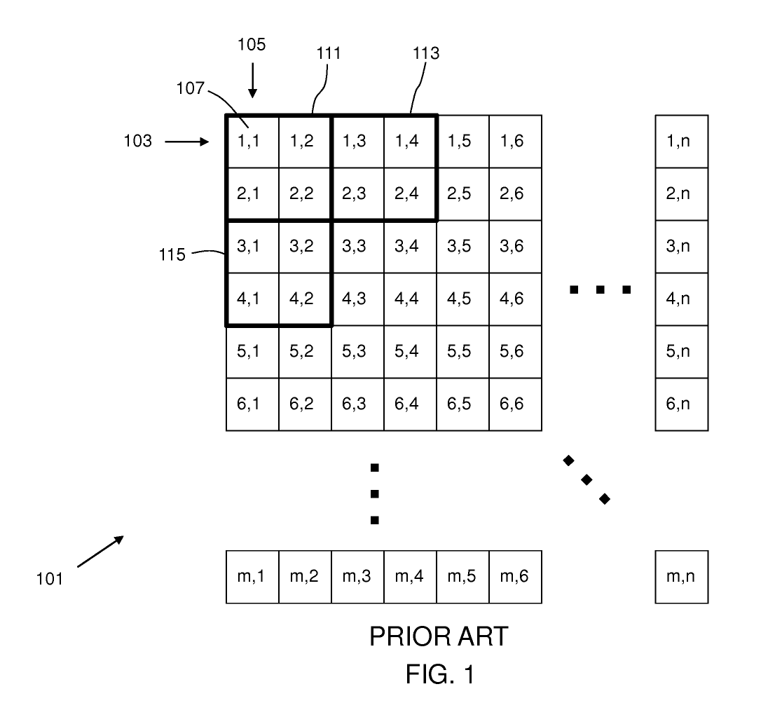

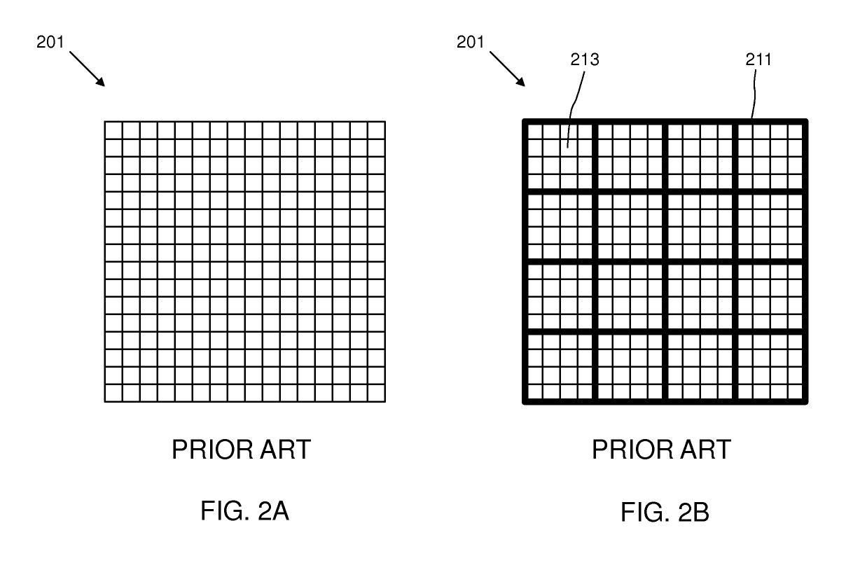

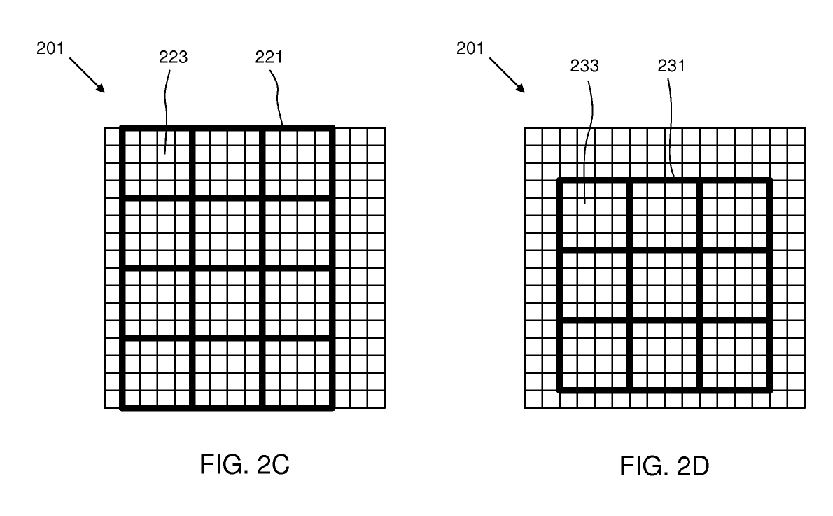

The use of super pixels as described above in FIG. 1 may be considered a form of downsampling, in which an image is smoothed and then downsampled to a lower resolution. Refer to FIGS. 2A through 2D, which are used to disclose a technique that will be referred to herein as “offset downsampling”. FIG. 2A shows a 16×16 array of raw pixels 201, such as what may be found on an image sensor. FIG. 2B shows how the 16×16 array of raw pixels 201 may be downsampled by a factor of 4 to a 4×4 array of super pixels. Note the downsampling grid 211 that denotes the borders of the super pixels. Each bold square of the downsampling grid 211 represents a 4×4 block of raw pixels that is electronically merged into one super pixel, using either of the two aforementioned methods or any other appropriate method. For example super pixel 213 is computed from the top left 4×4 block of raw pixels. Note that in FIG. 2B the placement of the downsampling grid 211 is placed flush against the boundary of the raw array 201.

FIG. 2C depicts the 16×16 array of raw pixels 201 downsampled by a factor of 4 with a horizontal offset. Each super pixel is computed from a 4×4 block of raw pixels. However the downsampling grid 221 is offset to the right by one raw pixel. For example super pixel 223 is computed from the raw pixels of rows 1 through 4 and columns 2 through 5. Note that because of the offset, only a 4×3 array of super pixels may be computed. This is because if the downsampling grid 221 were extended to the right, it would define super pixel regions that are not entirely on the raw pixel array 201. The downsampling grid 221 is similarly not extended to the left and thus does not cover the first column of raw pixels. The raw pixels at the left and right edges of the raw image and that are not within the downsampling grid 221 are thus discarded.

FIG. 2D depicts the 16×16 array of raw pixels 201 downsampled by a factor of 4 with both a horizontal and vertical offset. Super pixel 233 is computed from the raw pixels of rows 4 through 7 and columns 3 through 6, with the downsampling grid 231 as shown. In this case, only a 3×3 array of super pixels may be computed. The raw pixels not within the downsampling grid 231 are thus discarded, which results in raw pixels on all four edges of the 16×16 array 201 being discarded.

Offset downsampling as depicted in FIGS. 2C, and 2D may be implemented using the same methods as introduced above, including but not limited to the techniques introduced in the aforementioned U.S. Pat. Nos. 5,949,483 and 7,408,572. When using the first prior art method, for example as described in U.S. Pat. No. 7,408,572, super pixels may be formed by shorting all raw pixels within a super pixel together, and then reading out and acquiring one of the raw pixel values from each super pixel. When using the second prior art method, for example as described in U.S. Pat. No. 5,949,483, a super pixels may be formed by integrating the charge of all raw pixels within that super pixel, and then digitizing and acquiring the resulting charge. It will be understood that this technique may be applied to other raw array sizes and to other super pixel sizes and shapes. When this technique is applied to larger raw pixel array sizes, for example to arrays having thousands or millions of pixels, the loss of a few raw pixels at the edge of the raw pixel array will have a negligible effect on the total amount of image information acquired.

For purposes of discussion, we introduce the following terminology for offset downsampling, when performed with rectangular or square shaped super pixels. The “downsampling amount” will refer to the size of the super pixel, and may be a single number if the super pixel is square shaped. The teachings below will discuss primarily square shaped super pixels, but it will be understood that the techniques below can be applied to super pixels of any shape or size. The “offset” will refer to the offset of the super pixel array in raw pixels. For example, in FIG. 2C the raw image 201 is downsampled by 4 with an offset of 1 to the right, and in FIG. 2D the raw image 201 is downsampled by 4 with an offset of 2 to the right and 3 down. A downsampling grid will be referred to as “having no offset” if it is flush against the left and top sides of a raw pixel array, for example downsampling grid 211 of FIG. 2B. A downsampling grid will be referred to as “having offset” if it not flush against both the left and top sides of the raw array, for example downsampling grids 221 and 231 respectively of FIGS. 2C and 2D. We also define the “relative offset” between two downsampling grids to be the distance between the two downsampling grids in raw pixels. For example downsampling grids 231 has a relative offset of 1 raw pixel to the right and 3 raw pixels downward when compared to downsampling grid 221.

Offset downsampling has the benefit of generating the effect of sub pixel shifts from the perspective of the super pixel array. For example, suppose the raw pixel array 201 shown in FIGS. 2A through 2D hold an image. Suppose we construct a first 4×3 image from all super pixels of FIG. 2B except the right most column of super pixels, and then we construct a second 4×3 image from all super pixels of FIG. 2C. The first and second 4×3 images will be similar except for an apparent quarter pixel shift in the horizontal direction.

Parallax

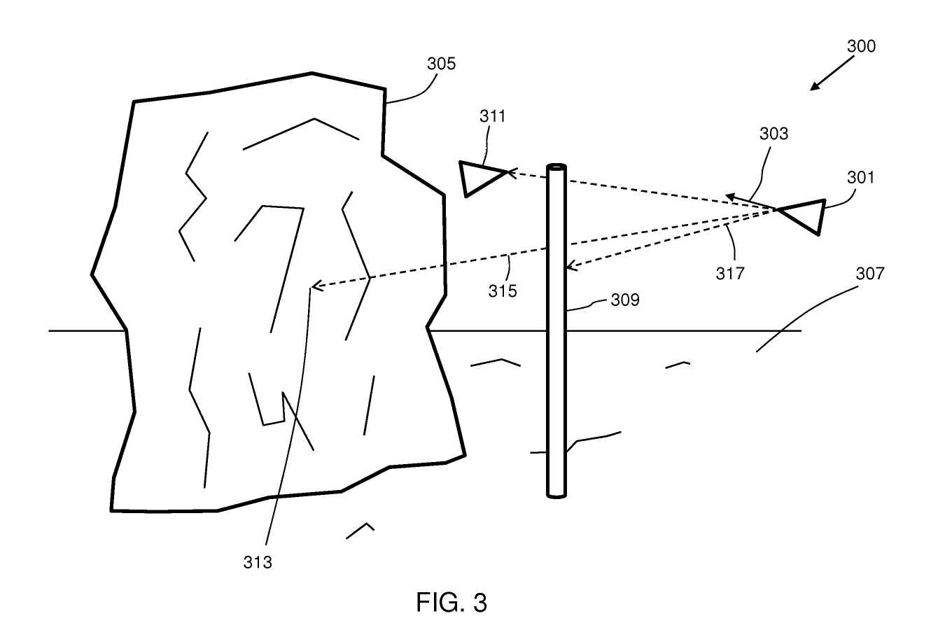

As will be further explained below, if a camera system including an image sensor is mounted on a moving platform, offset downsampling may be used to help detect objects in the environment. The basic principle is known as parallax. Refer to FIG. 3, which is used to describe parallax as observed by a moving platform in an environment 300. In FIG. 3 a moving platform such as an air vehicle 301 (depicted as a triangle) is traveling in a direction 303. Other objects in the environment include a large rock 305, the ground 307, a pole 309, and a second air vehicle 311. Suppose there is a camera system including an image sensor mounted in the air vehicle 301. It is desirable for the camera system to be able to detect these other objects, including the pole 309 and the second air vehicle 311. Suppose that when viewed from the air vehicle 301, the pole 309 is closer to the air vehicle 301 than the rock 305 and appears in front of the rock 305. Suppose the second air vehicle 311 is similarly positioned between the rock 305 and the air vehicle 301. The large rock 305 may be detected using optical flow computations. To detect the pole 309 and the second air vehicle 311, the camera system mounted on the first air vehicle 301 may use parallax that occurs between the pole 309 and the large rock 305 behind the pole 309 to detect the pole 309, and may similarly use parallax between the second air vehicle 311 and the large rock 305 to detect the second air vehicle 311. Alternatively, it is also possible to use parallax of either the pole 309 or second air vehicle 311 and a point on another background such as the ground 307 to detect these objects.

To help intuitively understand parallax, suppose the air vehicle 301 is a flying animal such as a bird rather than an artificial object. In this case the camera system in the air vehicle 301 would be an eye of the bird (or other animal). Typically the animal would have a pair of eyes that would fixate on various objects in the environment. Suppose the animal's eye fixates onto point 313 of the large rock 305. Suppose also that the direction of travel 303 of the bird 301 is a direction other than direction 315 towards point 313. Then there would be parallax between the pole 309 and the large rock 305. This parallax would manifest itself as the pole 309 appearing to move relative to the large rock 305 while the eye of the bird 301 is fixating on point 313. This parallax would also manifest itself by a change in the angle between ray 315 and ray 317, in which ray 317 denotes a direction from the bird 301 to a point on pole 309. Similarly there would be parallax between the second air vehicle 311 and the large rock 305, unless the second air vehicle 311 were moving in a manner to appear perfectly still against the large rock 305 background. The principle of parallax will be used in the teachings below with offset downsampling to detect objects such as the pole 309 and the second air vehicle 311.

First Exemplary Algorithm

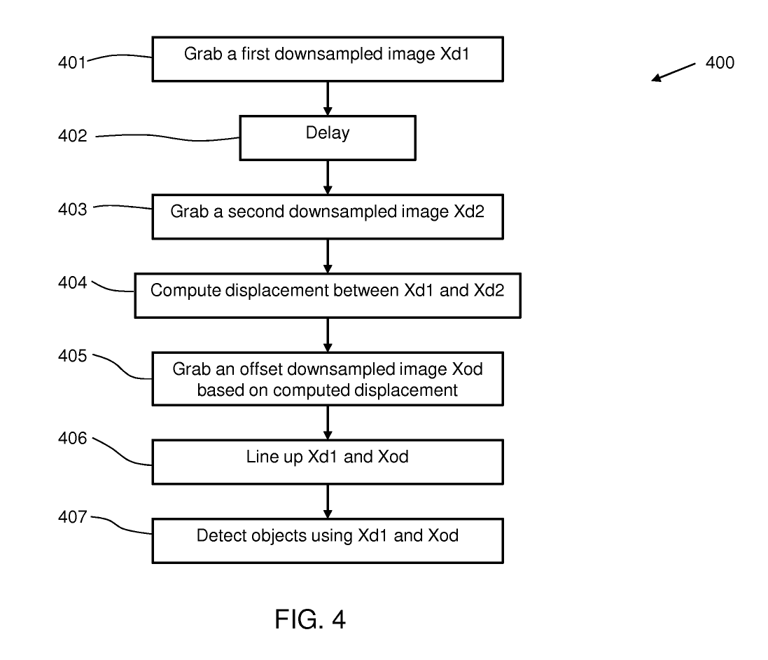

Refer to FIG. 4, which depicts a first exemplary algorithm 400 for detecting objects by parallax and by using offset downsampling. This algorithm may be performed on an camera system having an image sensor, a lens for focusing light from the environment onto an image sensor, and a processor for acquiring and processing pixel values from the image sensor. The camera system may be mounted on a platform such as air vehicle 301 so that it is moving through the environment. For purposes of discussion and without loss of generality, this algorithm is described assuming the use of an image sensor having a raw resolution of 256×256 pixels and that allows downsampling by a factor of eight in both directions and that supports offset downsampling. Downsampling may be performed either of the two prior art methods described above. The algorithm may be described by the following seven steps:

Step #1 401: The first step is grab a downsampled image Xd1. Image Xd1 may be obtained without use of offset downsampling so that a 32×32 image of super pixels is obtained from the raw 256×256 pixel array, with super pixel 1,1 generated from the averages of the 8×8 block of raw pixels from rows 1 through 8 and columns 1 through 8.

Step #2 402: The second step is to delay. This will allow the camera system to move through the environment and generate parallax.

Step #3 403: The third step is to grab a second downsampled image Xd2. Image Xd2 may also be obtained without the use of offset downsampling to generate a 32×32 image of super pixels in the same manner as that used to generate Xd1.

Step #4 404: The fourth step is to compute the displacement between Xd1 and Xd2. This may be performed using an optical flow algorithm or similar algorithm. This algorithm should be able to measure both horizontal and vertical displacements and should be able to compute these displacements to a precision of less than a pixel. Essentially the “displacement” between Xd1 and Xd2 is the amount Xd1 needs to be shifted, including sub-pixel shifts, to best match Xd2. The unit of measurement of this displacement measurement would thus be “super pixels”. It is also beneficial for this algorithm to be quick, so that Step 404 is executed in as short a time as possible. A sample optical flow algorithm that may be used is the Image Interpolation Algorithm (IIA) which is disclosed in the publication “An image-interpolation technique for the computation of optical flow and egomotion” by M. V. Srinivasan, pages 401-415 of the September 1994 issue of Biological Cybernetics (Vol. 71, No. 5) and incorporated herein by reference in its entirety. A MATLAB implementation of this algorithm is listed below as the function “ii2”. This function may be called with Xd1 and Xd2 used as inputs X1 and X2 to the algorithm, and argument “delta” being 1 or another positive integer. It will be understood that other algorithms may be used to obtain a displacement measurement between Xd1 and Xd2, including but not limited to the venerable Lucas Kanade optical flow algorithm. If the delay in Step #2 402 is sufficiently large that the displacement is more than a few super pixels, then it may be beneficial to first compute a coarse displacement to integer precision, and then refine the displacement measurement to a subpixel precision with a second computation.

% ===================================================
function [ofx,ofy] = ii2(X1,X2,delta)
% function [ofx,ofy] = ii2(X1,X2,delta)
% computes optical flow using 2D variant of Srinivasan's image
% interpolation algorithm
%
% X1, X2 = first and second image frame
% delta = delta shift for computation
% ofx,ofy = returned optical flow in pixels
%
[fm,fn] = size(X1);
ndxm = 1+delta:fm−delta;
ndxn = 1+delta:fn−delta;
f0 = X1(ndxm,ndxn);
fz = X2(ndxm,ndxn);
f1 = X1(ndxm,ndxn+delta);
f2 = X1(ndxm,ndxn−delta);
f3 = X1(ndxm+delta,ndxn);
f4 = X1(ndxm−delta,ndxn);
A = sum(sum( (f2−f1).\hat{ }2 ));
B = sum(sum( (f4−f3).*(f2−f1) ));
C = 2*sum(sum( (fz−f0).*(f2−f1) ));
D = sum(sum( (f2−f1).*(f4−f3) ));
E = sum(sum( (f4−f3).\hat{ }2 ));
F = 2*sum(sum( (fz−f0).*(f4−f3) ));
mat = [A B; D E];
invmat = inv(mat);
xyhat = invmat * [C;F];
ofx = delta*xyhat(1);
ofy = delta*xyhat(2);
% ===================================================

Step #5 405: The fifth step is to grab an offset downsampled image Xod based on the computed displacement between images Xd1 and Xd2. In the exemplary algorithm 400, the offset is equal to the computed displacement multiplied by the downsampling amount, with this product rounded to the nearest integer. For example, suppose the computed displacement from Xd1 to Xd2 were 0.51 super pixels horizontally to the right and 0.37 super pixels vertically downward. The horizontal and vertical offsets used for offset downsampling would respectively be 4 pixels to the right (0.51×8=4.08 which rounds to 4) and 3 pixels downward (0.37×8=2.96 which rounds to 3). In this case, Xod would be a 31×31 image of super pixels, with super pixel 1,1 generated from the 8×8 block of raw pixels of rows 4 through 11 and columns 5 through 12. This is because the downsampling grid for the 32nd row and 32nd column of super pixels would be partially off the raw pixel array, and thus invalid.

If either of the computed displacements are negative, then the first column and/or the first row of super pixels would similarly be invalid. For example, a negative horizontal displacement would result in the downsampling grid of the first column of super pixels being partially off the raw pixel array on the left. Thus the first column of super pixels would be invalid. Other super pixels that are located entirely on the raw pixel array however would still be valid.

It is beneficial for this step to be performed right after Step #3 403 with as little delay as possible.

Step #6 406: The sixth step is to line up Xd1 and Xod. Essentially Xd1 and Xod are cropped so that they are the same size and so that the apparent motion between them, as computed above in Step 404, is substantially eliminated. Since offset downsampling is used to compute Xod, it is possible that Xod will have a different number of pixels than X1 and that some of the pixels of Xod are invalid. In this case, X1 and possibly Xod will need to be cropped at the edges so that they are the same size and line up. The amount of cropping should take into account the magnitude and signs of the measured displacement. Larger displacements will generally result in X1 and Xod being cropped by a greater amount yielding smaller images. We present the following examples as illustrations:

### Example 1

Suppose the measured displacement from Step 404 is 0.25 super pixels to the right and zero super pixels down. The horizontal and vertical offsets used for offset downsampling would respectively be 2 raw pixels to the right (0.25×8=2) and zero raw pixels down. The downsampling grid used for grabbing Xod would thus be shifted to the right by 2 raw pixels. The result is that the right column of super pixels defined by the downsampling grid would be invalid. Xod would thus contain a 32×31 array of super pixels. X1 would thus be cropped to eliminate the right most column to also produce a 32×31 array of super pixels. After cropping, images Xod and X1 would essentially “line up” so that the original displacement of 0.25 super pixels between X1 and X2 is substantially eliminated.

### Example 2

Suppose the measured displacement from Step 404 were instead 0.25 super pixels to the left instead of to the right, and the vertical displacement were again zero. The downsampling grid would then be shifted to the left by 2 raw pixels, which would make the left column of super pixels invalid. Xod would again contain a 32×31 array of super pixels. X1 would thus be cropped to 32×31, but with the left most column of super pixels eliminated. The left most column of X1 would be eliminated because they correspond to the invalid left column of super pixels of Xod.

### Example 3

Let us consider a more extreme case with larger displacements in both horizontal and vertical directions. This would require cropping both X1 and Xod in order for the resulting downsampled images to line up. Suppose the measured displacement from Step 404 is 3.51 super pixels to the left and 1.36 super pixels down. The horizontal and vertical offsets used for offset downsampling would respectively be 28 raw pixels to the left (3.51×8=28.08 which rounds to 28) and 11 pixels down (1.36×8=10.88 which rounds to 11). The downsampling grid used for grabbing Xod would thus be shifted to the left by 28 raw pixels and down by 11 raw pixels. The result would be that the left four columns of super pixels defined by this downsampling grid would be invalid, as would the last two rows of super pixels. Thus X1 would be cropped on the left to keep just columns 5 through 32 and cropped on the bottom to keep just rows 1 through 30. Xod would be cropped on the opposite sides to delete the right four columns and first two rows of super pixels, and would thus keep columns 1 through 28 and rows 3 through 32. Both Xod and X1 would be the same size of 30×28 super pixels.

If the measured horizontal displacement from Step 404 is to the right, then X1 would be cropped to remove the right-most columns, and Xod would be cropped to remove the left-most columns if necessary. Similarly if the measured horizontal displacement from Step 404 is to the left, then X1 would be cropped to remove the left-most columns, and Xod would be cropped to remove the right-most columns if necessary.

If the measured vertical displacement from Step 404 is downward, then X1 would be cropped to remove the bottom rows, and Xod would be cropped to remove the top rows if necessary. Similarly if the measured vertical displacement from Step 404 is upward, then X1 would be cropped to remove the top rows, and Xod would be cropped to remove the bottom rows if necessary.

If Steps #1 through #6 are performed properly, the two lined-up images Xd1 and Xod should be almost the same throughout most of the image with a possible small residual jitter or sub-pixel displacement between the two images. Under ideal conditions, this jitter may be less than the reciprocal of the downsampling amount, or one eighth a pixel in the current example. If the camera is observing a scene where no parallax exists, for example a flat wall with texture, then the two lined up images may be almost identical. If there is a small object that visually moves against the background due to parallax, the two lined up images would be different at the locations of the small object. The effect of Steps 401 through 406 would be analogous to the example of the air vehicle 301 being a bird, and the bird's eye fixating on a background while the bird is moving. The difference is that the bird fixates by mechanically moving its eye, while Steps #1 through #6 above fixates electronically in the camera system.

Step #7 407: The seventh step is to detect objects using the lined up and cropped images Xd1 and Xod. Suppose there is an object in between the camera and a background and camera is moving so that there is parallax between the background and the object. Images Xd1 and Xod will be similar, except for the areas occupied by the moving object. This may make it easy to detect the moving object using a number of different techniques. For detecting objects that have contrast with respect to the background, for example by being generally brighter than or darker than the background, a simple frame-difference may be computed, e.g. computing D=Xd1−Xod. The region of the frame difference corresponding to the object will have a magnitude that is larger than other areas of the image. For some cases a simple thresholding may used, for example all pixels of D whose magnitude is greater than a threshold are candidate locations for the object. Contiguous regions of pixels of D having a magnitude greater than the threshold may be stronger candidates for locations of the object. In some cases computing and thresholding D will be adequate for detecting the object.

In other cases strong contrast edges in the background itself combined with residual jitter may cause regions of D associated with these strong contrast edges with larger magnitudes. In this case other techniques such as computing the optical flow between Xd1 and Xod may be used to detect the object. This may be performed by applying the above MATLAB function ii2 to different subregions throughout the two images. Most areas of the image will have a small optical flow corresponding primarily to any residual jitter between Xd1 and Xod. However areas of the image which contain the moving object may contain a large optical flow. Any region with a large optical flow is a candidate region for the location of the object. For example, the approximately 32×32 arrays of Xd1 and Xod (minus any cropping) may be divided into a 4×4 array of fields, each having an 8×8 array of super pixels. The optical flow may be computed in each of these sixteen fields. Field sizes other than 8×8 may be used, and the fields may be overlapping so as to generate more optical flow measurements. Any field with an optical flow above a set threshold is a candidate location for an object.

In many applications it will be possible to use the frame different matrix D or an array of optical flow measurements between Xd1 and Xod to detect moving objects. In other applications more sophisticated image processing algorithms may be useful. For these latter cases the techniques listed in the four aforementioned books on image processing may be used.

Variations of the First Exemplary Algorithm

It will be understood that a number of variations to the algorithm 400 of FIG. 4 are possible. In the first variation, either or both of the downsampled images Xd1 and Xd2 may be grabbed with offset downsampling. In this case, the offset used to grab Xod should take into account the offset already used when grabbing Xd1 and Xd2. For example, suppose Xd1 was grabbed with no offset, and Xd2 was grabbed with horizontal offset of 2 raw pixels to the right. Suppose the computed displacement between Xd1 and Xd2 is 0.75 super pixels to the right or 3 raw pixels to the right. Then Xod may be grabbed with offset downsampling with an offset of 2+3=5 pixels to the right.

In another variation, multiple iterations of exemplary algorithm 400 may be performed to effectively process multiple frames over time. In order to reduce the number of frames acquired at each step, it is possible to just use the offset downsampled image computed from the previous iteration. For example, for the first iteration of exemplary algorithm 400 one can compute Xd1, Xd2, and then Xod as discussed above and then detect objects using Xd1 and Xod. Then for the next iteration of exemplary algorithm 400, one can set Xd1 equal to the old Xod, and then after a delay grab the new Xd2 with or without offset downsampling. When grabbing the new Xod, however, one should take into account the offset used in grabbing the new Xd1 (e.g. the old Xod) and the new Xd2 in order to determine the offset for grabbing the new Xod. This variation has the advantage that the second iteration (and any subsequent iteration) requires grabbing only two downsampled images instead of three, which speeds up execution time.

Another variation accounts for delay between performing Steps 403 and 405. If the camera system is moving at a fast rate, or if Steps 403 or 404 take too much time to compute, then it may be necessary to account for additional displacement that may accumulate during Steps 403 and 404. Let t₁ equal the time interval between the start of Step 401 and the start of Step 403. Let t₂ equal the time interval between the start of Step 403 and the start of Step 405. If dx and dy are the respective horizontal and vertical displacements computed in Step 404, then it may be advantageous to respectively use

$$\begin{matrix}cx = d x \frac{{t}_{1} + {t}_{2}}{{t}_{1}} & ( Equation 1 ) \\ and & \\ cy = d y \frac{{t}_{1} + {t}_{2}}{{t}_{1}} & ( Equation 2 )\end{matrix}$$

instead of dx and dy to compute the offsets for grabbing Xod. This calculation assumes that the camera is undergoing constant motion, which for many applications is a reasonable linear approximation.

If the camera is undergoing more complicated motions, for example if mounted on a rapidly maneuvering air vehicle, then an IMU (inertial measurement unit) comprising gyros and/or accelerometers may be used to further adjust cx and cy to compute the offsets for grabbing Xod.

Second Exemplary Algorithm

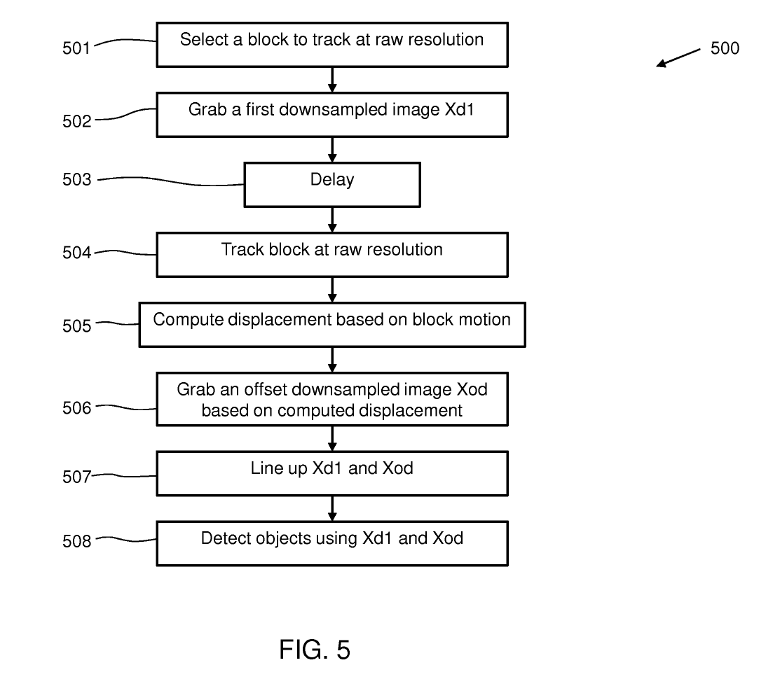

Refer to FIG. 5, which depicts a second exemplary algorithm 500 for detecting objects by parallax and by using offset downsampling. This algorithm is similar to algorithm 400 of FIG. 4 except for the method of computing displacements. Again, for purposes of discussion and without loss of generality, exemplary algorithm 500 will be explained in the context of the same camera system having a raw resolution of 256×256 pixels and the ability to downsample by a factor of eight including with an offset.

Step #1 501: The first step is to select a block for tracking at the raw resolution e.g. using the 256×256 raw pixel array. The block may be a small patch or block of pixels, for example of size 11×11 or 21×21 raw pixels or a similar size that is substantially smaller than the 256×256 raw pixel array. This block will be tracked over time thus it is beneficial for the block to contain texture or visual features that allow two dimensional motion to be tracked without ambiguity. Sample features may include corners or bright or dark spots. It is beneficial to avoid features such as edges. The classic Harris corner detector may be used to select block locations. The Harris corner detector is described in the paper “A combined corner and edge detector”, by C. Harris and M. Stephens, in the Proceedings of the Alvey Vision Conference, pages 147-151, published in 1988, which is incorporated herein by reference.

Step #2 502: The second step is to grab a first downsampled image Xd1. This step may be performed in the same manner as Step 401 of the previously described algorithm.

Step #3 503: The third step is to delay, which will allow the camera system to move through the environment and generate parallax in the same manner as Step 402 above.

Step #4 504: The fourth step is to track the block at raw resolution. Using a block matching or a feature tracking algorithm, the new location of the block of texture selected in Step #1 is determined. This step is performed on the 256×256 raw resolution image. The current location of the block may be found by searching the neighborhood of pixels around the block's original location to find the same sized patch of pixels that best matches the original block. Note that in most applications it is not necessary to grab the entire 256×256 array of raw pixels. Instead only the search region around the block needs to be grabbed, thus saving processing time and memory. The tracking of the block may be performed using a variety of block matching or feature tracking algorithms. One possibility is to use the MATLAB function “blockmatch”, the source code of which is listed below. For example, suppose the block from Step 501 is stored in variable W and is positioned so that the upper left pixel is located at raw pixel i,j=100,150 of the raw array (e.g. row 100 and column 150), and that the block has a size of 20×20 raw pixels. Suppose we select the size of the neighborhood to be 10 raw pixels, e.g. we will allow for the block to move by up to 10 raw pixels between Step 501 and Step 504. The size of the neighborhood may be selected based on the system and environment in which exemplary algorithm 500 is used. The search space X would be constructed by grabbing the 40×40 block of raw pixels from rows 90 through 129 and columns 140 through 179. The MATLAB function blockmatch may be called with X, W, and variable method set to 0, 1, 2, or 3. The new row location of the block will be i+bm−11 and the new column location of the block will be j+bn−11.

```
% ====================================================
function [bm,bn,best] = blockmatch(X,W,method)
% function [bm,bn,best] = blockmatch(X,W,method)
% Find the location of the W-sized window in X that is most
% similar to W
%
% X = search space
% W = prototype window
% method:
% 0 = variation of differences
% 1 = sum of abs(differences)
% 2 = sum of differences.\hat{ }2
% 3 = sum of differences.\hat{ }3
%
% bm,bn = location of upper left corner of best W-sized window
% best = best matching metric achieved
%
[xm,xn]=size(X);
[wm,wn]=size(W);
best = 1e20;
for m=1:xm−wm+1
    for n=1:xn−wn+1
        Xw = X( m:m+wm−1 , n:n+wn−1 );
        if method==0
            diffs = Xw−W;
            diffsmean = mean(mean(diffs));
            val = sum(sum( (diffs−diffsmean).\hat{ }2 ));
        elseif method==1
            val = sum(sum( abs(Xw−W) ));
        elseif method==2
            val = sum(sum( (Xw−W).\hat{ }2 ));
        elseif method==3
            val = sum(sum( abs((Xw−W).\hat{ }3) ));
        else
            val=0;
        end
        if val<best
            best=val;
            bestm = m;
            bestn = n;
        end
    end
end
bm=bestm;
bn=bestn;
% ====================================================
```

Step #5 505: The fifth step is to compute a displacement based on the motion of the block. In this exemplary algorithm 500, this displacement is simply the distance traveled by the block between the performance of Step 501 and Step 504. For example, if the block selected in Step 501 were located at pixel 105,131 on the raw 256×256 array, and by Step 504 the block had moved to pixel 107,135, then the displacement is two pixels down and four pixels to the right.

It will be understood that the result of Steps 504 and 505 is analogous to the result of Steps 403 and 404 as described in the first exemplary algorithm 400.

Step #6 506: The sixth step is to grab an offset downsampled image Xod based on the computed displacement. This step may be performed similarly to Step 405 of the exemplary algorithm 400. The difference is that in exemplary algorithm 500 the computed step will already be in raw pixel units therefore there is no need to multiply by the downsampling factor.

Step #7 507: The seventh step is to line up Xd1 and Xod. This may include cropping pixels from the edges of Xd1 and Xod as needed, and may be performed in a manner similar to that of Step 406 above. The effect of Steps #1 through #7 would be similar to the example of the air vehicle 301 being a bird, and the bird's eye fixating on a point, for example point 313 in FIG. 3, (analogous to the block) while the bird is moving.

Step #8 508: The eighth step is to detect objects based on the cropped images Xd1 and Xod. This step may be performed in the same manner as Step 407 above. Exemplary algorithm 500 may be more suitable for some applications than exemplary algorithm 400, in particular when the moving object being detected is large enough that it can affect the displacement measurement computed in Step 404 of the first exemplary algorithm 400. In the second exemplary algorithm 500, moving objects will not affect displacement measurements unless they enter the location of the block being tracked.

Variations of the Second Exemplary Algorithm

It will be understood that a number of variations to the second exemplary algorithm 500 of FIG. 5 are possible. In the first variation, Steps 503 and 504 may be repeated several times before the algorithm advances to Step 505, optionally with shorter delays in Step 503. This allows the block to be easily tracked over a larger time period, which may allow more parallax to be accumulated. If shorter delays are used in Step 503, it will generally be easier to track the motion of the block, since it will have moved a shorter distance in each iteration of Steps 503 and 504.

Another variation is to perform multiple iterations of exemplary algorithm 500 but track the same block. For example, suppose the algorithm 500 is performed once, generating an old Xd1 and an old Xod. The algorithm 500 may be performed again, but using the old Xod as the new Xd1 and computing a new Xod when Step 506 is performed again. If during the first iteration of algorithm 500 the block did not move too close to the edge and if it did not warp or change shape too much, then it may be possible to reuse the same block rather than acquire a new one. This skipping of step #1 would save processing time. In this case, the offset used to compute the old Xod should be taken into account when computing the offset used to compute the new Xod. A new block may be grabbed when the current block reaches the edge of the image, becomes corrupted by the object entering it, or otherwise warps or adequately changes to necessitate the acquisition of a new block.

Another variation is to account for delay between performing Steps 504 and 506. This may be performed in the same manner as described above for the algorithm 400 of FIG. 4, using Equations 1 and 2, and taking into account the appropriate delays. In this case, t₁ may be the time interval between the start of Step 501 and the start of Step 504, and t₂ may be the time interval between the start of Step 504 and the start of step 506.

Another set of variations are possible by using a feature detecting algorithm in place of block matching when performing Steps 501 and 504. For example, algorithms such as “Scale Invariant Feature Transform (SIFT)”, which is described in U.S. Pat. No. 6,711,293 by David G. Lowe may be used. Another feature detecting algorithm that may be used is described in “SURF: Speeded Up Robust Features”, by Herbert Bay et. al. in Computer Vision and Image Understanding (CVIU), Vol. 110, No. 3, pp. 346-359 and published in 2008. In this variation, in Step 501 a feature detecting algorithm such as SIFT or SURF may be used to identify a feature of interest in the raw 256×256 image. Then in Step 504 the same feature detecting algorithm may be used to identify the new location of the feature. Since algorithms such as SIFT and SURF construct a descriptor vector associated with each feature, it may be easier match up candidate features using descriptor vectors (e.g. to solve the “correspondence problem” when matching up features between two image frames) to track the motion of the feature between Steps 501 and 504. The displacement computed in Step 505 may then be determined by how far the feature has moved between Steps 501 and 504. If the delay in Step 503 is adequately short, then in Step 504 it will not be necessary to search over the entire raw 256×256 image which will reduce computations required. This variation has the advantage that the type of features selected and tracked in SIFT and SURF tend to be robust against rotations or other distortions, which for some applications may allow a larger delay in Step 503 to be used or may allow use in a more visually cluttered environment. The term “token” may be used to refer to such a feature being tracked, whether the tracking is performed using SIFT, SURF, or block matching as described above.

Third Exemplary Algorithm

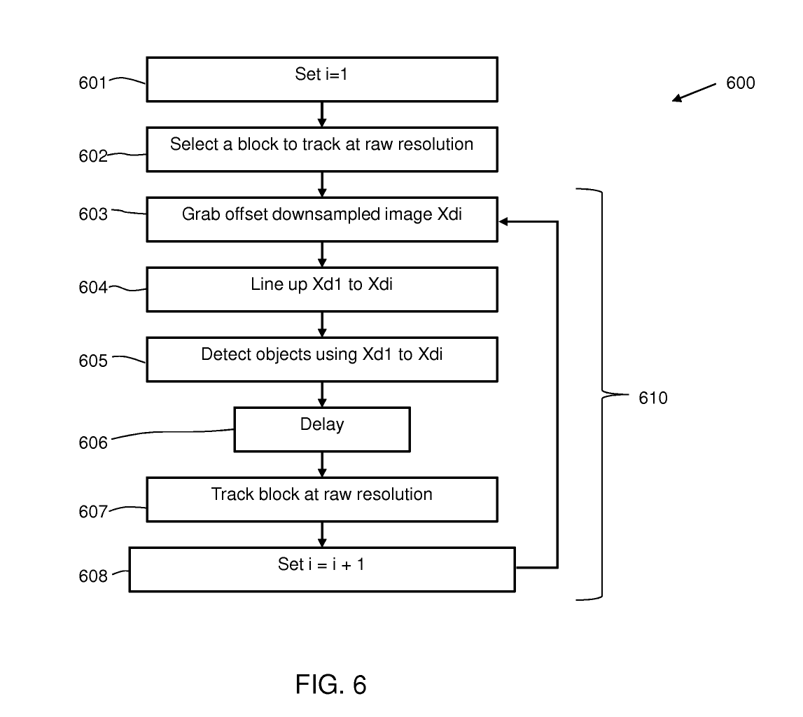

Refer to FIG. 6, which depicts a third exemplary algorithm 600 for detecting objects by parallax and by using offset downsampling. This algorithm is similar to the algorithm 500 of FIG. 5 except that more than two offset downsampled images are acquired and objects are detected based on these offset downsampled images. This exemplary algorithm will be explained in the context of the same camera system described in the two above exemplary algorithms. Steps 601 and 602 initialize the algorithm, while steps 603 through 608 are performed multiple times in a loop 610 as shown.

Step #1 601: The first step is to initialize variable i to one. Variable i will be used to denote successive acquired offset downsample images.

Step #2 602: The second step is to select a block to track at raw resolution e.g. using the 256×256 raw pixel array. This may be performed in the same manner as that of Step 501 from the second exemplary algorithm 500.

Step #3 603: The third step is to grab an offset downsampled image Xdi. This may be performed in the same manner as described above. For the first time this step is performed, e.g. for i=1, the image Xd1 may be acquired without offset downsampling. In future iterations of this step, first a displacement measurement may be generated based on the differences between the current position of the block and the initial position from Step 601, then Xdi may be acquired with an offset according to the computed displacement.

Step #4 604: The fourth step is to line up image Xd1 through Xdi. This step may be performed in the same manner as steps 406 and 507 of the previous exemplary algorithms, except that the images may be lined up and cropped based on all images Xd1 through Xdi.

Step #5 605: The fifth step is to detect objects based on offset downsampled images Xd1 through Xdi. This step will be discussed further below.

Step #6 606: The sixth step is to delay the algorithm, so that the camera system may move through the environment and generate parallax in the same manner as Steps 402 and 503 above.

Step #7 607: The seventh step is to track the block at raw resolution. This may be performed in the same manner as Step 504 above.

Step #8 608: The eight step is to increment variable i. Then the algorithm goes back to Step 603 to begin the loop 610 of Steps 603 through 608 again. Every time loop 610 is repeated, another offset downsample image Xdi is acquired and the block is again tracked in the visual field.

We will now discuss Step #5 605. In the first iteration of loop 610 there is only one downsampled image Xd1, thus there are not enough pictures to detect objects by parallax. In this case Step 605 is skipped. For later iterations, e.g. for i=2, 3, and so on, there are enough downsampled images to begin looking for objects by parallax. As additional downsampled images are acquired and lined up, the following characteristic of the images may be observed: Some regions of the images will undergo little change except for any residual jitter and any slow distortions due to change in pose, slow expansion, and so forth. This is particularly true if the block is locked onto a large object that itself is not moving, in which case all parts of the images associated with the large object may undergo such little change. Other regions of the image, on the other hand, may undergo significantly more motion and may be easily detected. This is particularly true if there are objects moving in a path that may generate significant parallax.

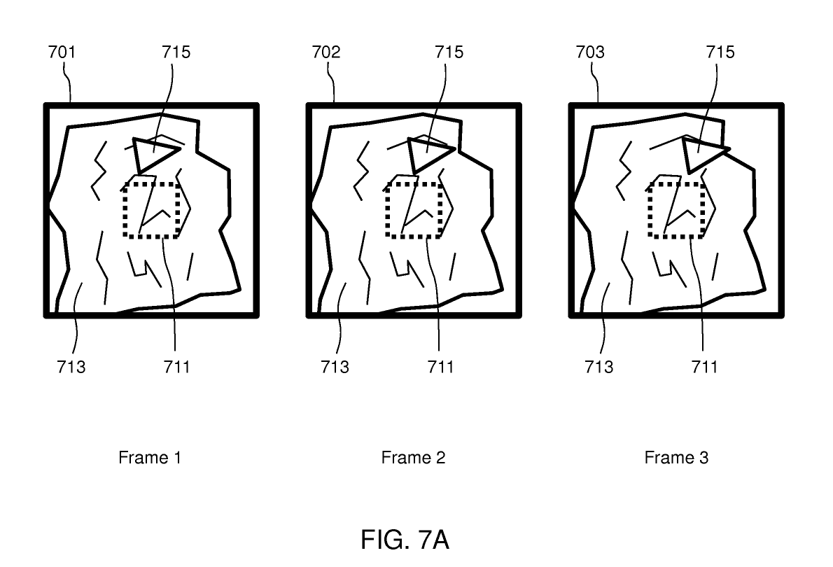

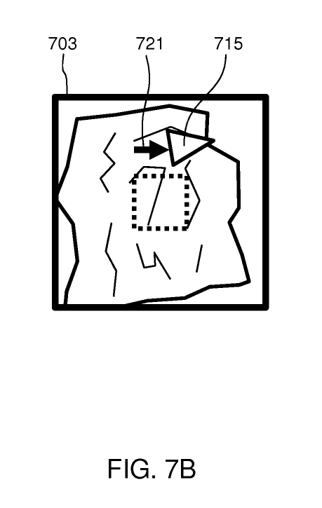

Refer to FIG. 7A, which depicts three sequential frames 701, 702, and 703 of offset downsampled images used as an example. These sequential frames may be, for example, images Xd1, Xd2, and Xd3 grabbed from three iterations of loop 610, after lining up and cropping. In each of these images, a tracking block 711 identified by the dotted line square is locked onto texture on a rock 713, for example the rock 305 depicted in FIG. 3. Over the three sequential images 701, 702, and 703, the tracking block 711 and the rock 713 may be relatively unchanged, except for the aforementioned distortions. However this sample environment also contains a moving target 715 in the shape of a triangle that is moving right at a constant velocity in a manner that generates parallax. This triangle may correspond to the second air vehicle 311 depicted in FIG. 3. In FIG. 7A, this moving target 715 generates enough parallax so that it's motion is clearly observed over the three sequential frames 701, 702, 703. This motion may be observed and measured, as shown in FIG. 7B, which shows the third frame 703 of FIG. 7A with the motion 721 of the moving target 715 clearly indicated. Image processing techniques such as those described in the aforementioned four books on image processing may be used to detect and track the moving target 715.

One significant advantage of the use of offset downsampling in this manner is that sequential images are constructed in a manner that apparent visual motion due to translation and rotation of the camera system is eliminated, leaving behind motion due to parallax. This parallax motion may then be easier to compute since the parallax motion may dominate all visual motion within the scene.

Variations of the Third Exemplary Algorithm

It will be understood that all of the variations described above for the second exemplary algorithm may be applied to the third exemplary algorithm. This includes, for example, accounting for the delay between Step 607 and the subsequent Step 603, which may be performed using Equations 1 and 2 above using the appropriate time intervals. This also includes using a feature tracking algorithm such as SIFT or SURF to identify and locate a feature in place of tracking a block with a block matching algorithm.

Another set of variations are possible by performing further processing on the sequence of grabbed downsampled images. As described above, the portions of the images associated with texture from an object observed in the tracking block may undergo little motion between adjacent frames, since offset downsampling generally removes all horizontal and vertical motion except for a small amount of sub-pixel jitter. However over a larger number of frames, other distortions may become apparent. For example, suppose in the example of FIGS. 7A and 7B the camera system were moving towards the rock 713. Over time, the rock may appear to expand as the camera system approaches it. Algorithms that measure looming or expansion may be used to detect the approaching rock 713. If instead the camera system were moving sideways in a path around the rock 713, the rock 713 may appear to rotate in place. Both these and other similar motions may be more easily detected from the offset downsampled images generated by algorithm 600 than from a set of raw images alone.

Other Variations

It will be understood that raw pixel array sizes other than 256×256 may be used, as may other downsampling amounts and super pixel sizes be used for offset downsampling. Other variations applicable to all the above exemplary algorithms may be implemented. For example, as described above, an IMU (inertial measurement unit) comprising accelerometers and angular rate gyros may be used to help compute the displacement in the appropriate steps of the above exemplary algorithms. Such an IMU may be useful in particular when there is non-negligible delay between a tracking or displacement computing step and a step for grabbing offset downsample images, for example between steps 403 and 405, between steps 504 and 506, or between step 607 and the subsequent iteration of step 603. The IMU may be used to refine the displacement measurement as performed using Equations 1 and 2 above.

In other variations, it may be possible to obtain displacements by a method other than visual. This may be the case if the IMU is accurate enough that the IMU measurements are alone adequate to compute the required displacement. For example the camera system may be mounted on a high flying air vehicle undergoing rotations in place, and the IMU may include a gyro accurate enough to direct the offset downsampling operation so that background motion is removed. In yet another variation, the camera system may be used in a structured and known environment, and may be moved in a controlled manner. In this case, it may be possible to compute the displacements for directing offset downsampling based on the known motion of the camera system and the dimensions of the environment. A simple example would be if the camera were mounted on a linear actuator and looking sideways at a target of a known distance. Another example would be if the camera were fixed but observing a known environment moving at a known velocity. In either of these variations, the above three exemplary algorithms may be simplified. The first exemplary algorithm 400 may be modified by deleting Step 403, and modifying Step 404 so that the displacement is computed based on the IMU measurements or the known motion of the camera system. A similar modification to the second exemplary algorithm 500 would yield essentially the same algorithm as the modified first exemplary algorithm. The third exemplary algorithm 600 may similarly be modified, with Steps 602 and 607 deleted, and with Step 603 modified to use IMU measurements to compute the offsets used for offset downsampling.

Another variation may be made to the second 500 and third 600 exemplary algorithms. There is a chance that an object to be detected enters the region of the tracking block or even occludes it. Such an event may disrupt the computation of displacement. To improve the robustness of these algorithms to such a scenario, it is possible to use more than one tracking block. Effectively multiple instances of the exemplary algorithms 500 and 600 may run in parallel, each with a different tracking block. One set of offset downsampled images may be generated based on each tracking block, and then the results of the object detection algorithms fused to derive a more robust result. Alternatively, a single displacement may be generated from an average or other aggregate of all tracking block displacements, which is then used to generate just one set of offset downsampled images. In this latter case, if many tracking blocks are used, each generating a displacement measurement, then the displacement measurements may be analyzed for the presence of outliers. The outlier displacement measurements may then be removed from the average. The removal of such outliers may help remove the effects of individual tracking blocks being disrupted by objects entering them.

Another variation to the above exemplary algorithms is to implement offset downsampling in software. Rather than using an image sensor capable of electronically binning raw pixels together to form super pixels, it is possible for a processor to digitize and acquire all raw pixels from an image sensor, and then compute each super pixel by computing the sum, average, or other aggregation of the raw pixels within the super pixel. This method has the advantages that any image sensor may be used, and multiple offset downsampled images may be computed from the same raw image values. The latter advantage allows, for example, Steps 403 and 405 to be computed from the same raw pixel array so that the visual field will be effectively unchanged between grabbing Xd2 and Xod. In other words, for Equations 1 and 2 above, the effective value of t₂ would be zero. The method of implementing offset downsampling in software has the obvious disadvantage that all the raw pixels of an image sensor may need to be digitized and stored, which may require a faster processor or limit the speed at which the algorithms are used.

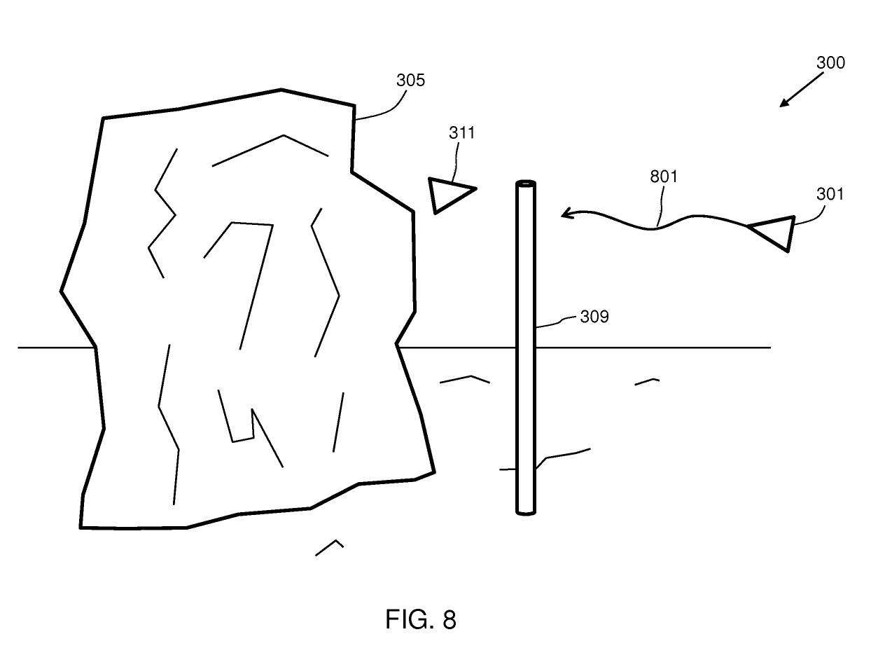

The above teachings have many applications which may be realized. The applications of detecting both moving targets and still obstacles by parallax from a moving platform has already been discussed, in particular in FIGS. 3 and 7. The ability of a camera system to detect objects using the above teachings may be accentuated by having the camera system undergo motion along a controlled path. Refer to FIG. 8, which shows the same visual scene 300 of FIG. 3, except that the first air vehicle 301 is traveling in a serpentine path 801. By traveling along a serpentine path 801, the camera system on the air vehicle 301 may undergo sideways motions as it travels forward to help generate parallax. This may help the camera system aboard the air vehicle 301 detect obstacles like the pole 309 using parallax between the pole 309 and the rock 305, in particular if the serpentine path 801 has horizontal components which are perpendicular to the orientation of the pole 309. Such a serpentine flight path may be used to detect a variety of obstacles such as cables, tree trunks, vines, or other narrower or smaller obstacles that are not readily detected by optical flow expansion alone. It should be noted that the technique of traveling along a serpentine type path may be applied to camera systems on other vehicles besides air vehicles, such as ground vehicles or underwater vehicles.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the inventions have been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

I claim:

1. A method for generating a first image and a second image based on a visual scene, comprising the steps of:
acquiring a first downsampled image based on the visual scene;
acquiring a second downsampled image based on the visual scene;
selecting a displacement;
computing an offset downsampled image based on the displacement and the visual scene;
generating the first image based on the first downsampled image; and
generating the second image based on the offset downsampled image.

2. The method of claim 1, wherein the displacement is computed based on the first downsampled image and the second downsampled image.

3. The method of claim 2, wherein the displacement is computed additionally based on an optical flow measurement between the first downsampled image and the second downsampled image.

4. The method of claim 3, wherein the displacement is computed additionally based on a first time interval and a second time interval.

5. The method of claim 1, wherein the first downsampled image, the second downsampled image, and the offset downsampled image are computed with an image sensor, and each pixel of the first downsampled image, the second downsampled image, and the offset downsampled image is a super pixel.

6. The method of claim 5, wherein the image sensor comprises:
a first circuit capable of generating an array of signals based on the visual field;
an array of switches capable of shorting signals of the array of signals according to a selectable downsampling grid;
a readout circuit capable of generating a second array of signals based on the array of signals; wherein
the first downsampled image is generated based on the second array of signals when the selectable downsampling grid is set to a first downsampling grid;
the second downsampled image is generated based on the second array of signals when the selectable downsampling grid is set to a second downsampling grid;
the offset downsampled image is generated based on the second array of signals when the selectable downsampling grid is set to a third downsampling grid; and
the third downsampling grid is selected based on the displacement.

7. The method of claim 1, further comprising a step of detecting one or more objects based on the first image and the second image.

8. The method of claim 7, wherein the method is implemented in a system associated with a moving platform.

9. The method of claim 8, wherein the one or more objects are obstacles.

10. The method of claim 8, wherein the one or more objects are moving objects.

11. The method of claim 8, wherein the moving platform is an air vehicle.

12. The method of claim 1, wherein the displacement is computed based on an inertial measurement.

13. The method of claim 12, wherein the displacement is computed additionally based on a first time interval and a second time interval.

14. A method for generating a plurality of images based on a visual field, comprising the steps of:
acquiring a first downsampled image based on the visual field;
selecting one or more displacements;
acquiring a plurality of offset downsampled images based on the one or more displacements and based on the visual field; and
generating the plurality of images based on the plurality of offset downsampled images.

15. The method of claim 14, wherein the one or more displacements is computed based on the visual field.

16. The method of claim 15, wherein each displacement of the one or more displacements is computed based on a first time interval associated with the displacement and a second time interval associated with the displacement.

17. The method of claim 14, further comprising the step of detecting one or more objects in the visual field based on the plurality of images.

18. The method of claim 17, wherein the method is implemented in a system associated with a moving platform.

19. The method of claim 18, wherein the one or more objects are obstacles.

20. The method of claim 18, wherein the one or more objects are moving objects.

21. The method of claim 18, wherein the moving platform is an air vehicle.

22. The method of claim 17, further comprising a step of computing a plurality of parallax measurements based on the plurality of images, and wherein the one or more objects are detected additionally based on the plurality of parallax measurements.

23. The method of claim 22, wherein the one or more objects are detected additionally based on parallax motion between the one or more objects and a background.

24. The method of claim 15, wherein the step of computing the one or more displacements comprises the steps of:
selecting a block from a raw image based on the visual field; and
computing one or more locations of the block at different times and based on the visual field; wherein
the one or more displacements is computed based additionally on the one or more locations of the block.

25. The method of claim 15, wherein the step of computing the one or more displacements comprises the steps of:
selecting a feature from a raw image based on the visual field; and
computing one or more locations of the feature based on the visual field; wherein the one or more displacements is computed based additionally on the one or more locations of the feature.

26. The method of claim 25, wherein the one or more locations of the feature is computed using the SIFT algorithm or the SURF algorithm.

27. The method of claim 14, wherein the one or more displacements is computed based on a plurality of inertial measurements.

28. A method for generating a pair of images based on a visual field, comprising the steps of:
selecting a token based on the visual field, based on a first pixel pitch, and based on a first time instance;
grabbing a first downsampled image based on the visual field and based on a second pixel pitch;
computing a displacement based on the token, based on a second time instance, and based on the visual field;
grabbing an offset downsampled image based on the displacement, based on the second pixel pitch, and based on the visual field;
generating the first image of the pair of images based on the first downsampled image; and
generating the second image of the pair of images based on the offset downsampled image.

29. The method of claim 28, wherein the first pixel pitch is smaller than the second pixel pitch.

30. The method of claim 28, further comprising a step of computing a plurality of parallax measurements based on the pair of images.

31. The method of claim 28, further comprising a step of detecting one or more objects based on the pair of images.
